(19) United States
(12) Patent Application Publication
(10) Pub. No.: US 2025/0151165 A1
(43) Pub. Date: May 8, 2025

(54) METHOD AND UE FOR SIGNALLING MULTICAST BROADCAST SERVICES INTEREST INDICATION

(71) Applicant: SAMSUNG ELECTRONICS CO., LTD., Suwon-si (KR)

(72) Inventors: Vinay Kumar SHRIVASTAVA, Bangalore (IN); Sangkyu BAEK, Suwon-si (KR)

(21) Appl. No.: 18/935,298

(22) Filed: Nov. 1, 2024

(30) Foreign Application Priority Data
Nov. 2, 2023 (IN) 202341074858
Oct. 18, 2024 (IN) 202341074858

(51) Int. Cl. H04W 76/40; H04W 76/27

(52) U.S. Cl. CPC H04W 76/40; H04W 76/27

(57) ABSTRACT

The disclosure relates to a 5G or 6G communication system for supporting a higher data transmission rate. The present disclosure relates to method 300a and UE 101 for signalling multicast broadcast services (MBS) interest indication (MII). The method comprises of sending, to a source cell an MII message. The method further comprises of receiving from the source cell, one of: RRC_Reconfiguration or RRC_Reconfiguration with reconfigurationWithSync. The RRC_Reconfiguration or RRC_Reconfiguration with reconfigurationWithSync is received during UE mobility. The method further comprises of connecting with a target cell upon receiving one of: RRC_Reconfiguration or RRC_Reconfiguration with reconfigurationWithSync. The method finally comprises of sending the MII message to the target cell.

### CROSS-REFERENCE TO RELATED APPLICATIONS

This application is based on and claims priority under 35 U.S.C. § 119 to Indian Provisional Patent Application No. 202341074858 filed on Nov. 2, 2023, and Indian Non-Provisional Patent Application No. 202341074858 filed on Oct. 18, 2024, in the Indian Intellectual Property Office, the disclosure of which is/are incorporated by reference herein in its/their entirety.

### BACKGROUND

### 1. Field

The present subject matter is related in general to telecommunication network, more particularly, but not exclusively, the present subject matter relates to a method and user equipment (UE) for signalling multicast broadcast services (MBS) interest indication (MII) in communication systems.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A user equipment (UE) can be associated with one or more cells, carriers, frequencies, bandwidth parts (BWPs), cell groups (e.g., master cell group (MCG) or secondary cell group (SCG)), tracking areas (TAs), non-public networks (NPNs), public land mobile networks (PLMNs), networks, subscriber identity modules (SIMs) and mobile network operators (MNOs) or simply, termed as operators.

It is possible for the UE to receive services (e.g., unicast, multicast, broadcast services) on one or more networks or operators. There may or may not be coordination across these networks or operators. Further, there may be no uplink signalling with respect to various broadcast reception states such as, broadcast reception in radio resource control—idle (RRC_IDLE) or radio resource control—inactive (RRC_INACTIVE). Resultantly, the concerned network may not be aware about the UE receiving such services like the broadcast service.

For simplicity, at most two networks/operators are considered herein, without loss of generality. In an example, consider a UE is receiving unicast service(s) on a network (NW)—A managed by operator X, and the UE is further receiving broadcast service(s) on another network (NW)-B managed by operator Y. In this scenario, NW-A may not be aware about the UE receiving broadcast service(s) as this information is not signalled to the NW-B, as the UE may be in an RRC_IDLE or an RRC_INACTIVE state. Even if the information is signalled to the NW-B, the NW-B may not have any coordination with NW-A. As NW-A is not aware about the UE receiving broadcast service(s) on NW-B and resultantly, some of baseband or hardware resource (processing) capabilities of the UE are used up in supporting these service(s). Therefore, NW-A may have wrong assessment/information of the UE capabilities and may wrongly configure the UE with the configurations which are not suitable. For example, NW-A may configure the UE with a full-fledged configuration (e.g., a carrier aggregation configuration with maximum number of component carriers or serving cells or a dual connectivity) assuming full baseband resource or processing capability. However, resultantly, the UE may not be able to support the configuration and/or will not function in an optimum manner in terms of device or service performance and/or satisfactory user experience.

To generalize, it is possible that the UE receives unicast services from a serving cell and multicast broadcast services (MBS) from non-serving cell(s) pertaining to either a same network or different networks. Moreover, the networks may belong to the same or different operators. Thus, there is a need for the UE to inform the serving cell regarding cell broadcast reception status on the non-serving cell(s), such that the serving cell can suitably configure the UE considering its available baseband resource or processing capability.

Further, the UE may encounter two scenarios related to RRC reconfiguration with sync which may occur during mobility of the UE e.g., handover, and RRC reestablishment which may take place when a radio link failure occurs. In these scenarios, transmission of the MBS interest indication (MII) message may not be reliable and there is a need to ensure robustness of the MII transmission. Moreover, it is possible that the target serving cell (also termed as primary cell or PCell) does not provide broadcast signalling for system information block index 21 (SIB21) and therefore, the UE may face an issue that MII transmission cannot be initiated.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

The purpose of this application is to be able to solve at least one of the drawbacks of the prior art.

In an embodiment, the present disclosure relates to a method for signalling multicast broadcast services (MBS) interest indication (MII). The method comprises of sending, to a source cell an MII message. The method further comprises of receiving from the source cell, one of: RRC_Reconfiguration or RRC_Reconfiguration with reconfigurationWithSync. The RRC_Reconfiguration or RRC_Reconfiguration with reconfigurationWithSync is received during UE mobility. The method further comprises of connecting with a target cell upon receiving one of: RRC_Reconfiguration or RRC_Reconfiguration with reconfigurationWithSync. The method finally comprises of sending the MII message to the target cell, when receiving from the target cell, SIB1 comprising a parameter nonServingCellMII.

In another embodiment, the present disclosure relates to a method for signalling multicast broadcast services (MBS) interest indication (MII). The method further comprises of sending to a source cell, an MII message. The method further comprises of executing a conditional reconfiguration. The method further comprises of connecting with a target cell based on the conditional reconfiguration. The method finally comprises of sending the MII message to the target cell, when receiving from the target cell, SIB1 comprising a parameter nonServingCellMII.

In another embodiment, the present disclosure relates to a method for signalling multicast broadcast services (MBS) interest indication (MII). The method comprises of sending, to a source cell an MII message. The method further comprises of receiving from the source cell RRCReestablishment. The RRCReestablishment is received during radio link failure. The method further comprises of connecting with a target cell based on RRCReestablishment. The method finally comprises of sending the MII message to the target cell, when receiving from the target cell, SIB1 comprising a parameter nonServingCellMII.

The present disclosure further relates to a user equipment (UE) for signalling multicast broadcast services (MBS) interest indication (MII). The UE comprises of a processor and a memory. The processor is configured to send to a source cell an MII message. The processor is further configured to receive from the source cell, one of: RRC_Reconfiguration or RRC_Reconfiguration with reconfigurationWithSync. The RRC_Reconfiguration or RRC_Reconfiguration with reconfigurationWithSync is received during UE mobility. The processor is further configured to connect with a target cell upon receiving one of: RRC_Reconfiguration or RRC_Reconfiguration with reconfigurationWithSync. The processor is finally configured to send the MII message to the target cell, when receiving from the target cell, SIB1 comprising a parameter nonServingCellMII.

The present disclosure further relates to a user equipment (UE) for signalling multicast broadcast services (MBS) interest indication (MII). The UE comprises of a processor and a memory. The processor is configured to send to a source cell, an MII message. The processor is further configured to execute a conditional reconfiguration. The processor is further configured to connect with a target cell based on the conditional reconfiguration. The processor is finally configured to send the MII message to the target cell, when receiving from the target cell, SIB1 comprising a parameter nonServingCellMII.

The present disclosure further relates to a user equipment (UE) for signalling multicast broadcast services (MBS) interest indication (MII). The UE comprises of a processor and a memory. The processor is configured to send to a source cell an MII message. The processor is further configured to receive from the source cell RRCReestablishment. The RRCReestablishment is received during radio link failure. The processor is further configured to connect with a target cell based on RRCReestablishment. The processor is finally configured to send the MII message to the target cell, when receiving from the target cell, SIB1 comprising a parameter nonServingCellMII.

The foregoing summary is illustrative only and is not intended to be in any way limiting. In addition to the illustrative aspects, embodiments, and features described above, further aspects, embodiments, and features will become apparent by reference to the drawings and the following detailed description.

Embodiments of the present disclosure provides methods and apparatus for signalling multicast broadcast services (MBS) interest indication (MII). Reliability and robustness of the MII transmission can be improved.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference features and components. Some embodiments of system and/or methods in accordance with embodiments of the present subject matter are now described, by way of example only, and regarding the accompanying figures, in which:

FIG. 1 illustrates an environment for signalling MBS MII in accordance with some embodiments of the present disclosure;

FIG. 2 illustrates UE in accordance with some embodiments of the present disclosure;

FIGS. 3A, 3B, and 3C illustrate flow diagram of an exemplary method for signalling MII between a UE and a communication network in accordance with some embodiments of the present disclosure;

FIGS. 4A, 4B, and 4C illustrate a message flow diagram of an exemplary method for signalling MII between a system and UE in accordance with some embodiments of the present disclosure;

FIG. 5 illustrates a computer system in accordance with some embodiments of the present disclosure;

FIG. 6 illustrates a flow diagram for MII transmission in the RRC reconfiguration with synchronization (sync) scenario in accordance with some embodiments of the present disclosure; and

FIG. 7 illustrates a flow diagram for MII transmission in the RRC reestablishment scenario in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

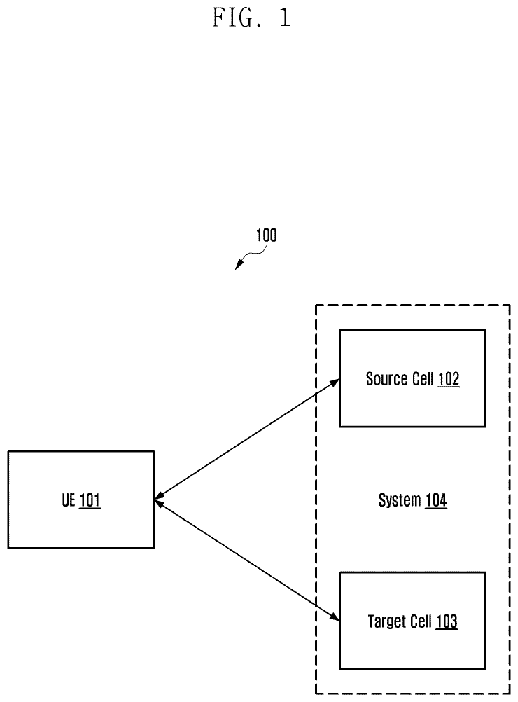

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises,” “comprising,” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “includes,” “including,” or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

The terms “an embodiment,” “embodiment,” “embodiments,” “the embodiment,” “the embodiments,” “one or more embodiments,” “some embodiments,” and “one embodiment” mean “one or more (but not all) embodiments of the disclosure(s)” unless expressly specified otherwise.

The terms “including,” “comprising,” “having” and variations thereof mean “including but not limited to,” unless expressly specified otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the term “user equipment” or “UE” may refer to any electronic device that may be transported and operated by a user, which may also provide remote communication capabilities to a network and supports cellular communication. Examples of remote communication capabilities include using a mobile phone (wireless) network, wireless data network (e.g., 5G or similar networks), or any other communication medium that may provide access to a communication network. Examples of user equipment includes mobile phones (e.g., cellular phones), PDAs, tablet computers, net books, laptop computers, personal computers etc. A mobile device may comprise any suitable hardware and software for performing such functions and may also include multiple devices or components (e.g., when a device has remote access to a network by tethering to another device—i.e., using the other device as a relay—both devices taken together may be considered a single mobile device).

As used herein, the term “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

As used herein, the term “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

As used herein, the term “SIB1” refers to “system information block 1,” and contains information relevant when evaluating if a UE is allowed to access a cell and defines the scheduling of other system information. It also contains radio resource configuration information that is common for all UEs and barring information applied to the unified access control.

As used herein, the term “conditional reconfiguration” refers to one of conditional handover that enables a UE to make a final decision on a handover execution timing based on monitoring radio channels, conditional addition or change of PCell.

As used herein the term “serving cell” may refer to a primary cell (PCell) in a mobile network responsible for managing the active radio connection, data transmission, and control signaling for the user equipment.

As used herein the term “non-serving cell” may refer to neighboring cell, such as a secondary cell (SCell) in carrier aggregation or a cell in a neighboring network, which is not actively handling the UE's connection but may be measured for potential handover or load balancing.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

An embodiment of present disclosure discloses methods and systems for robust interest indication signalling for multicast broadcast services (MBS) for new radio (NR), a 5th generation radio access technology (RAT). The present disclosure discloses how to signal an MBS interest indication (MII) reporting to the network, when a UE is receiving broadcast and unicast simultaneously from one or more networks.

The embodiments herein achieve methods and systems for robust interest indication signalling for multicast broadcast services (MBS) for new radio (NR), a 5th generation radio access technology (RAT). The embodiment of the present disclosure discloses how to signal the MBS interest indication (MII) reporting to the network, when a UE is receiving broadcast and unicast simultaneously from one or more networks.

In an embodiment, the NR MBS services may include multicast services, for which the network transfers common user data that is intended to be received only by a specific group of UEs which have joined a specific multicast group. Further, the NR MBS services may include broadcast services, for which the network transfers common user data that can be received by all UEs interested to receive the service.

The network may provide the MBS services in a limited part of the network and coverage area of MBS services may be one cell or larger.

The 5G core network (CN) may deliver MBS user data to the Radio Access Network (RAN) using various delivery methods such as individual delivery and shared delivery. In individual delivery, for each individual UE receiving the MBS service, the CN may deliver separate copies of the MBS user data packets to RAN (i.e., via per-UE PDU sessions, alike in case of unicast delivery). In shared delivery, the CN delivers a single copy of MBS user data to RAN i.e., via a shared PDU session/tunnel), with RAN handling delivery to one or multiple UEs.

Further, beside the MBS services, the UE may be engaged in unicast services as well, and in some scenarios, the UE can also avail the unicast services and the MBS services from one or more networks. To generalize, embodiments herein consider that the UE may receive unicast services from a serving cell and may further receive the MBS service from a non-serving cell belonging to the same or different networks.

In an embodiment, the UE may receive unicast on at least one serving cell on a first network and the UE may receive at least one MBS service (e.g., MBS broadcast) on at least one non-serving cell on a second network. The UE may report the MBS broadcast reception on the non-serving cell using the MII message to the serving cell. In another embodiment, the UE may report proactively the MII message to the serving cell before the UE actually starts receiving the MBS service on the non-serving cell. For example, though the UE is interested in the MBS broadcast service on non-serving cell, the service may still not be started. In another embodiment, the UE may not report the MII message to the serving cell when the unicast reception is not yet received on the serving cell and the UE is receiving or may be interested to receive the MBS service on the non-serving cell.

In an embodiment, when the UE may be in a radio resource control—connected (RRC_CONNECTED) state on the serving cell, the UE may initiate the MBS interest indication procedure on the serving cell corresponding to the MBS broadcast reception on the non-serving cell(s) in at least one of the following cases:
a) Upon start of broadcast reception from a non-serving cell;
b) Upon stop of broadcast reception from a non-serving cell;
c) Upon loss of interest in broadcast reception from a non-serving cell;
d) Upon gain of interest in broadcast reception from a non-serving cell;
e) Upon start of broadcast session from a non-serving cell;
f) Upon stop of broadcast session from a non-serving cell;
g) Upon loss of interest in broadcast session from a non-serving cell;
h) Upon gain of interest in broadcast session from a non-serving cell;
i) Upon change of frequency of the broadcast reception from a non-serving cell;
j) Upon change of bandwidth of the broadcast reception from a non-serving cell;
k) Upon change of common frequency resource (CFR) of the broadcast reception from a non-serving cell;
l) Upon losing coverage of the no-serving cell providing the broadcast reception; and/or
m) Upon change of sub-carrier spacing of the broadcast reception from a non-serving cell.

In an embodiment, robustness of MII transmission may be ensured for ReconfigurationWithSync and Reestablishment procedures. Further, the MII transmission may be initiated again, for the cases when MII was initiated during one second preceding reception of the RRCReconfiguration message or RRCReestablishment message, or after receiving RRCReconfiguration due to conditional reconfiguration execution.

In an embodiment, release-18 (Rel-18) MII transmission (i.e., related to shared processing for unicast and broadcast reception) is ensured for robustness when SIB21 is not broadcasted by a primary cell (PCell). The UE may receive unicast services on serving cell and further receive MBS broadcast services on non-serving cell. The MII transmission may essentially provide the UE's dynamic baseband or hardware processing capabilities due to simultaneous reception of the unicast services and the broadcast services. For Rel-18 MII, gNodeB (gNB) for serving cell is not required to provide any broadcast service, and SIB21 may not be broadcasted by the PCell. However, SIB1 including non-ServingCellMII is considered for the PCell to allow Rel-18 MII transmission. It is important that the gNB for the serving cell interprets Rel-18 MII for the non-serving cell information to use for unicast services scheduling. Therefore, the present disclosure considers non-servingCellMII provided in SIB1 by the PCell for initiating MII transmission during ReconfigurationWithSync and Reestablishment scenarios.

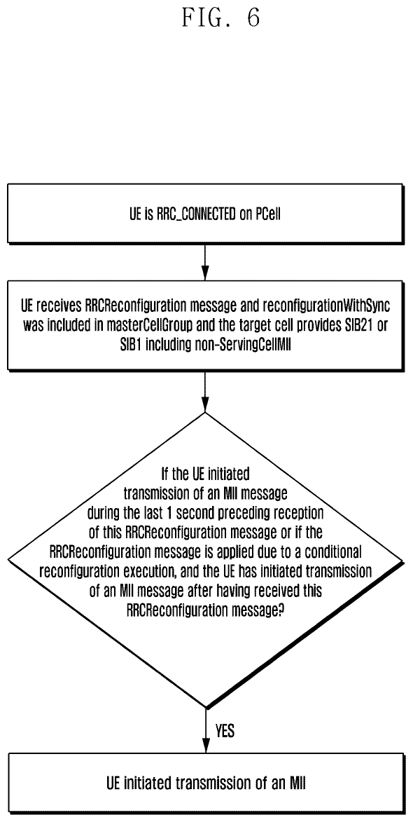

In an embodiment, as illustrated in FIG. 6, when non-servingCellMII is provided in SIB1 by the PCell, the UE initiates transmission of MII message during ReconfigurationWithSync scenario i.e., for the cases when MII transmission was initiated during one second preceding reception of the RRCReconfiguration message or after receiving RRCReconfiguration message due to conditional reconfiguration execution, wherein reconfigurationWithSync is included in the RRCReconfiguration message.

In an embodiment, an example for the specification is provided for handling reception of an RRCReconfiguration including reconfigurationWithSync by the UE and initiating a transmission of the MII message as below.

### Example 1

5.3.5.3 Reception of an RRCReconfiguration by the UE

```
The UE shall perform the following actions upon reception of the RRCReconfiguration, or
upon execution of the conditional reconfiguration (CHO, CPA, or CPC):
....<Omitted Text>........
1> if reconfigurationWithSync was included in spCellConfig of an MCG or SCG and when
  MAC of an NR cell group successfully completes a Random Access procedure triggered
  above; or,
1> if sl-PathSwitchConfig was  included  in reconfigurationWithSync included
  in spCellConfig of  an  MCG,  and  when successfully
  sending RRCReconfigurationComplete message (i.e., PC5 RLC acknowledgement is
  received from target L2 U2N Relay UE):
....<Omitted Text>........
  2> if reconfigurationWithSync was included in masterCellGroup and the target cell
    provides SIB21or provides SIB1 including non-ServingCellMII:
    3> if the UE initiated transmission of an MBSInterestIndication message during the last
      1 second preceding reception of this RRCReconfiguration message; or
    3> if the RRCReconfiguration message is applied due to a conditional reconfiguration
      execution,  and  the  UE  has  initiated  transmission  of
      an MBSInterestIndication message  after  having  received
      this RRCReconfiguration message:
      4> initiate transmission of an MBSInterestIndication message in accordance with
        clause 5.9.4;
```

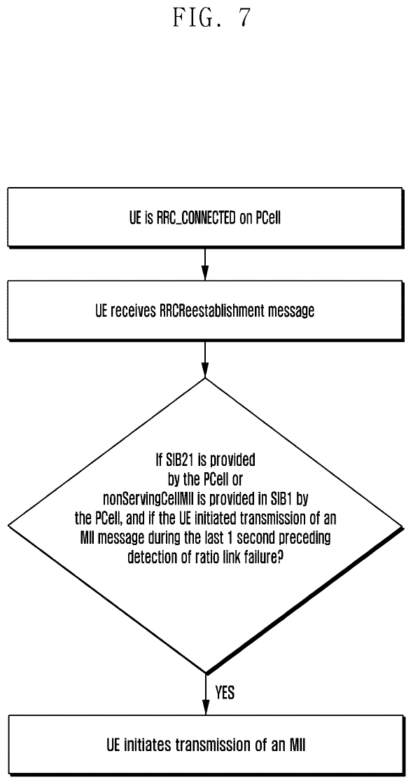

In an embodiment, as illustrated in FIG. 7, when non-servingCellMII is provided in SIB1 by the PCell, the UE may initiate transmission of MII message during reestablishment scenario i.e., for the case when MII message transmission was initiated during one second preceding reception of the RRCReestablishment message.

An example for the specification is provided for handling reception of an RRCReestablishment by the UE and initiating a transmission of the MII as below.

### Example 2

5.3.7.5 Reception of the RRCReestablishment by the UE

```
The UE shall:
....< Omitted Text>........
1> if SIB21 is provided by the PCell; or
1> if nonServingCellMII is provided in SIB1 by the PCell:
  2> if the UE initiated transmission of an MBSInterestIndication message during the last 1
    second preceding detection of radio link failure:
    3> initiate transmission of an MBSInterestIndication message in accordance with 5.9.4;
```

In an embodiment, the MBS interest indication (MII) message initiated during ReconfigurationWithSync and Reestablishment scenarios includes reporting for the MBS reception on the serving cell (when SIB21 is provided by the PCell) and/or reporting for the MBS reception (e.g., MBS broadcast) on the non-serving cell (when non-ServingCellMII is provided in SIB1 by the PCell). For example, for the cases when MII was initiated during one second preceding reception of the RRCReconfiguration message or RRCReestablishment message, or after receiving RRCReconfiguration due to conditional reconfiguration execution.

In an embodiment, the MBS interest indication message initiated during ReconfigurationWithSync and Reestablishment scenarios includes an empty report for the MBS reception on the serving cell (when SIB21 is not provided by the PCell but non-ServingCellMII is provided in SIB1 by the PCell) and/or an empty report for the MBS reception (e.g., MBS broadcast) on the non-serving cell (when SIB21 is provided by the PCell when non-ServingCellMII is not provided in SIB1 by the PCell). For example, for the cases when MII was initiated during one second preceding reception of the RRCReconfiguration message or RRCReestablishment message, or after receiving RRCReconfiguration due to conditional reconfiguration execution.

In an embodiment, the MBS interest indication (MII) message communicated from the source cell/gNB to the target cell/gNB during mobility scenarios (e.g., inter-node message exchange during handover) reporting for the MBS reception on the serving cell (when target cell/gNB supports MII reporting for MBS broadcast service on serving cell) and/or reporting for the MBS reception (e.g., MBS broadcast) on the non-serving cell (when target cell/gNB supports MII reporting for the MBS broadcast reception on non-serving cell).

In an embodiment, the MBS interest indication message communicated from the source cell/gNB to the target cell/gNB during mobility scenarios (e.g., inter-node message exchange during handover) includes an empty report for the MBS reception on the serving cell (when target cell/gNB does not support MII reporting for MBS broadcast reception on serving cell but supports MII reporting for the MBS broadcast reception on non-serving cell) and/or an empty report for the MBS reception (e.g., MBS broadcast) on the non-serving cell (when target cell/gNB supports MII reporting for MBS broadcast reception on serving cell but does not support MII reporting for the MBS broadcast reception on non-serving cell).

FIG. 1 illustrates an environment 100 for signalling multicast broadcast services (MBS) interest indication (MII). The environment 100 may comprise of a user equipment (UE) 101, a source cell 102 and a target cell 103. The various components such as the source cell 102 and the target cell 103 belong to a communication network and may be implemented as software or hardware components. The environment 100 may comprise of a system 104 for signalling MII and comprising of at least the source cell 102 and the target cell 103.

In an embodiment, the source cell 102 may be a serving cell and the target cell 103 may be a non-serving cell that may provide broadcast service. In an embodiment, the source cell 102 and the target cell 103 may belong to same or different networks/operators.

In an embodiment, the UE 101 may be configured to do the following. The UE 101 may be configured to send to the source cell 102 an MII message. The UE 101 is further configured to receive from the source cell, one of: RRC_Reconfiguration or RRC_Reconfiguration with reconfigurationWithSync. The RRC_Reconfiguration or RRC_Reconfiguration with reconfigurationWithSync is received during UE mobility. The UE 101 sends the MII message to the source cell during a time period preceding the reception of one of: RRC_Reconfiguration or RRC_Reconfiguration with reconfigurationWithSync. For example, if the UE 101 initiated transmission of an MBSInterestIndication message during the last one second preceding reception of this RRCReconfiguration message, then upon subsequent connection of the UE 101 with the target cell 102, the UE 101 may send the MII message to the target cell 103 in response to receiving SIB1 comprising nonServingCellMII from the target cell 103. In an embodiment, the UE 101 may connect with the target cell 103 upon receiving one of: RRC_Reconfiguration or RRC_Reconfiguration with reconfigurationWithSync.

In an embodiment, the MII message includes, without limitation to, a subcarrier spacing information, carrier frequency, frequency band indicator, common frequency resource (CFR) of one or more non-serving cells providing an MBS. Further, CFR may be represented as CFR bandwidth in terms of number of physical resource blocks or as CFR location and bandwidth.

In another embodiment, the UE 101 is configured to send, to the source cell 102, the MII message. The UE 101 may then be configured to execute a conditional reconfiguration. The UE may then be configured to connect with the target cell 103 based on the conditional reconfiguration. The UE 101 may then send the MII message to the target cell 103.

In an embodiment, the UE configured to connect with the target cell 103 is further configured to receive from the target cell 103, SIB1 comprising nonServingCellMII.

In another embodiment, the UE 101 is configured to send to the source cell 102 an MII message. The UE 101 is then configured to receive from the source cell 102, RRCReestablishment. The RRCReestablishment is received during radio link failure. The UE 101 is then configured to connect with the target cell 103 based on RRCReestablishment. The UE 101 subsequently sends the MII message to the target cell 103 in response to receiving SIB1 comprising nonServingCellMII from the target cell 103.

In an embodiment, the UE 101 sends the MII message to the source cell 102 during a time period preceding the reception of RRCReestablishment. For example, without limitation to, if the UE 101 initiated transmission of an MBSInterestIndication message during the last one second preceding reception of this RRCReconfiguration message, then upon subsequent connection of the UE 101 with the target cell 102, the UE 101 may send the MII message to the target cell 103 in response to receiving SIB1 comprising nonServingCellMII from the target cell 103.

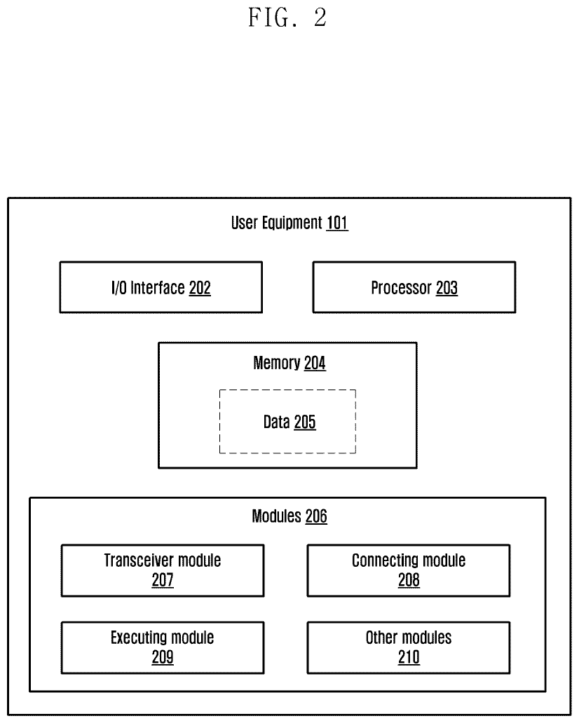

FIG. 2 illustrates a detailed a block diagram of a user equipment (UE) 101. The UE 101 may comprise of a processor 203, an input/output (I/O) interface 202, a memory 204 and modules 206. The memory 204 may further comprise of data 205. The modules 206 may further comprise of modules such as without limitation to, a transceiver module 207, a connecting module 208, an executing module 209, and other modules 210.

In an embodiment, the data 205 may include various temporary data and files generated by the modules 206.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In an implementation, each of the modules 206 may be configured as stand-alone hardware computing units. In an embodiment, the other modules 209 may be used to perform various miscellaneous functionalities of the UE 101. It will be appreciated that such the modules 206 may be represented as a single module or a combination of different modules.

In an embodiment, the transceiver module 207 may be configured to send to the source cell 102 the MII message. The transceiver module may then be configured to receive from the source cell 102 one of: RRC_Reconfiguration or RRC_Reconfiguration with reconfigurationWithSync. The RRC_Reconfiguration or RRC_Reconfiguration with reconfigurationWithSync is received during UE mobility. The UE 101 sends the MII message to the source cell 102 during a time period preceding the reception of one of: RRC_Reconfiguration or RRC_Reconfiguration with reconfigurationWithSync. For example, the time period may be, without limitation to, one second preceding the reception of RRC_Reconfiguration or RRC_Reconfiguration with reconfigurationWithSync.

In an embodiment, the MII message includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

The connecting module 208 may be configured to connect with the target cell 103 upon receiving one of: RRC_Reconfiguration or RRC_Reconfiguration with reconfigurationWithSync.

The transceiver module 207 may then be configured to receive from the target cell 103, SIB1 comprising nonServingCellMII. The transceiver module 207 may then be configured to send the MII message to the target cell 103.

In an embodiment, the source cell 102 may be a serving cell and the target cell 103 may be a non-serving cell that may provide broadcast service. In an embodiment, the source cell 102 and the target cell 103 may belong to same or different networks/operators.

In another embodiment, the transceiver module 207 is configured to send to the source cell 102 the MII message.

The executing module 209 is configured to execute a conditional reconfiguration based on radio link conditions. The connecting module 208 is then configured to connect with the target cell 103 based on the conditional reconfiguration. The transceiver module 207 is then configured to receive from the target cell 103, SIB1 comprising nonServingCellMII. The transceiver module 207 may be configured to send the MII message to the target cell 103.

In an embodiment, the MII message includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

In another embodiment, the transceiver module 207 is configured to send to the source cell 102 the MII message. The transceiver module 207 is configured to receive from the source cell 102, RRCReestablishment. In an embodiment, the RRCReestablishment is received during radio link failure.

The connecting module 208 is configured to connect with the target cell 103 based on RRCReestablishment. The transceiver module 207 is configured to receive from the target cell 103 SIB1 comprising nonServingCellMII. Subsequently transceiver module 207 is configured to send the MII message to the target cell 103.

The UE 101 sends the MII message to the source cell 102 during a time period preceding the reception of RRCReestablishment. For example, the time period may be, without limitation to, one second preceding the reception of RRCReestablishment.

In an embodiment, the MII message includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

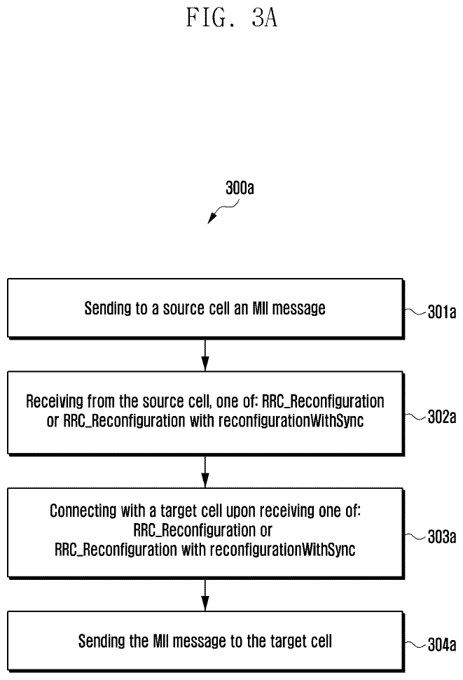

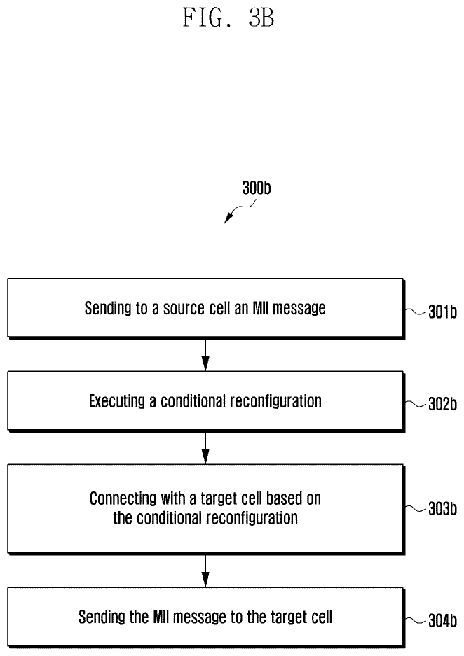

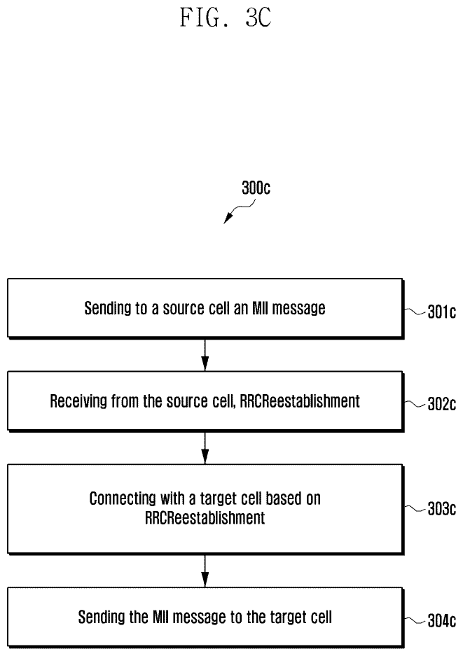

FIG. 3A, depicts a flow diagram of an exemplary method 300a for signalling MII between a UE and the communication network.

At step 301a, the UE 101 may send the MII message to the source cell 102. In an embodiment, the MII message includes at least one of: a subcarrier spacing information, carrier frequency, frequency band indicator, Common Frequency Resource (CFR) of one or more non-serving cells providing an MBS. Further, CFR may be represented as CFR bandwidth in terms of number of physical resource blocks or as CFR location and bandwidth.

At step 302a, the UE 101 may receive one of: RRC_Reconfiguration or RRC_Reconfiguration with reconfigurationWithSync from the source cell 102. The UE 101 sends the MII message to the source cell during a time period preceding the reception of one of: RRC_Reconfiguration or RRC_Reconfiguration with reconfigurationWithSync. For example, the time period may be, without limitation to, one second.

At step 303a, the UE 101 may connect with the target cell 103 upon receiving one of: RRC_Reconfiguration or RRC_Reconfiguration with reconfigurationWithSync. The UE may then receive SIB1 comprising nonServingCellMII from the target cell 103.

In an embodiment, the source cell 102 may be a serving cell and the target cell 103 may be a non-serving cell that may provide broadcast service. In an embodiment, the source cell 102 and the target cell 103 may belong to same or different networks/operators.

At step 304a, the UE 101 may send the MII message to the target cell. The MII message may include at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

FIG. 3B depicts a flow diagram of an exemplary method 300a for signalling MII between a UE and the communication network.

At step 301b, the UE 101 may send the MII message to the source cell 102. In an embodiment, the MII message includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth. The MII message is sent after receiving the RRCReconfiguration message.

At step 302b, the UE 101 may execute a conditional reconfiguration. The RRCReconfiguration message is applied due to conditional reconfiguration execution.

At step 303b, the UE 101 may connect with the target cell 103 based on the conditional reconfiguration. The UE 101 may then receive SIB1 comprising nonServingCellMII from the target cell.

In an embodiment, the source cell 102 may be a serving cell and the target cell 103 may be a non-serving cell that may provide broadcast service. In an embodiment, the source cell 102 and the target cell 103 may belong to same or different networks/operators.

At step 304b, the UE 101 may send the MII message to the target cell. The MII message may include at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

FIG. 3C depicts a flow diagram of an exemplary method 300a for signalling MII between a UE and the communication network.

At step 301c, the UE 101 may send the MII message to the source cell 102. In an embodiment, the MII message includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

At step 302c, the UE 101 may receive RRCReestablishment from the source cell 102. The UE 101 sends the MII message to the source cell during a time period preceding the reception of RRCReestablishment. For example, the time period may be, without limitation to, one second.

At step 303c, the UE 101 may connect with the target cell 103 based on RRCReestablishment. The UE may then receive SIB1 comprising nonServingCellMII from the target cell 103.

In an embodiment, the source cell 102 may be a serving cell and the target cell 103 may be a non-serving cell that may provide broadcast service. In an embodiment, the source cell 102 and the target cell 103 may belong to same or different networks/operators.

At step 304c, the UE 101 may send the MII message to the target cell. The MII message may include at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

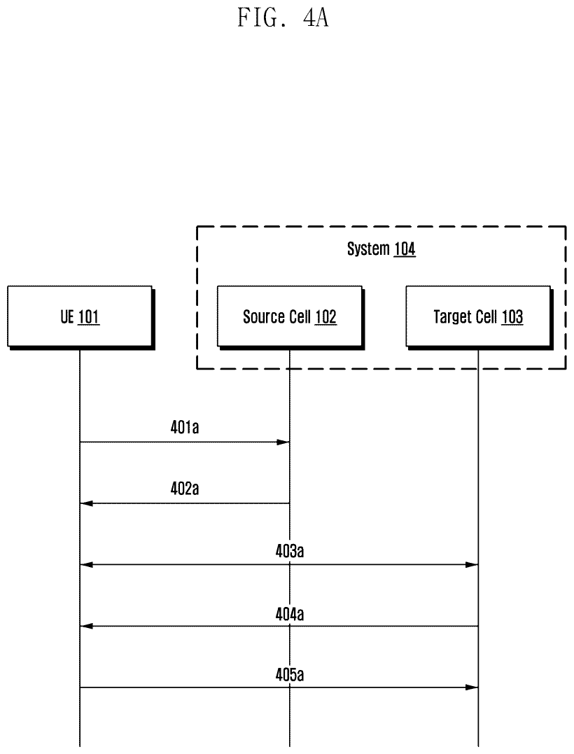

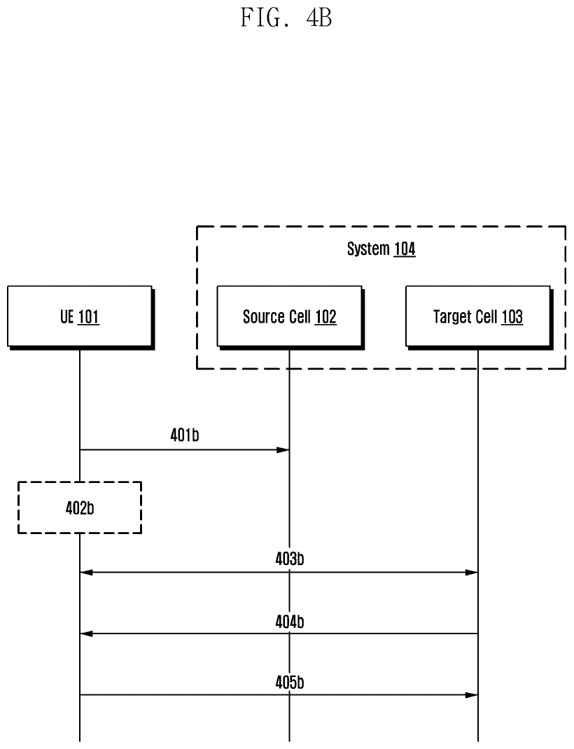

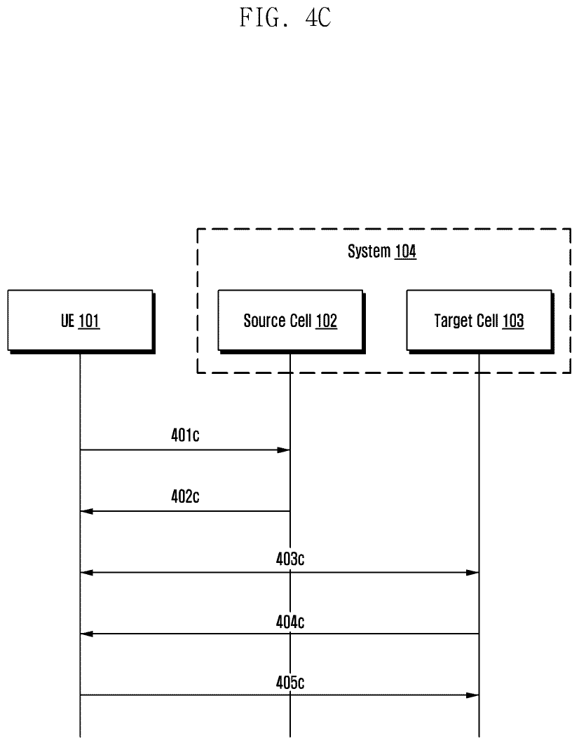

FIG. 4A depicts a message flow diagram of an exemplary method for signalling MII between a system 104 for signalling MII and the UE 101, in accordance with some embodiments of the present disclosure.

At step 401a, the source cell 102 of the system 104 is configured to receive from the UE 101 the MII message that includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

At step 402a, the source cell 102 of the system 104 may be configured to send one of: RRC_Reconfiguration or RRC_Reconfiguration with reconfigurationWithSync. The RRC_Reconfiguration or RRC_Reconfiguration with reconfigurationWithSync may be sent in the event of UE mobility. The source cell 102 may receive the MII message during a time period preceding sending of one of: RRC_Reconfiguration or RRC_Reconfiguration with reconfigurationWithSync. For example, if the UE 101 initiated transmission of an MBSInterestIndication message during the last one second preceding transmission of this RRCReconfiguration message by the source cell 102, then upon subsequent connection of the UE 101 with the target cell 102, the UE 101 may send the MII message to the target cell 103 in response to receiving SIB1 comprising nonServingCellMII from the target cell 103.

At step 403a, the target cell 103 may connect with the UE 101 based on the UE 101 receiving one of: RRC_Reconfiguration or RRC_Reconfiguration with reconfigurationWithSync.

At step 404a, the target cell 103 may send SIB1 comprising nonServingCellMII. To the UE 101.

At step 405a, the target cell 103 may receive the MII message from the UE 101.

FIG. 4B depicts a message flow diagram of an exemplary method for signalling MII between a system 104 for signalling MII and the UE 101, in accordance with some embodiments of the present disclosure.

At step 401b, the source cell 102 of the system 104 is configured to receive from the UE 101 the MII message that includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

At step 402b, the UE 101 may be configured to execute a conditional reconfiguration.

At step 403b, the target cell 103 may connect with the UE 101 based on based on the conditional reconfiguration executed by the UE 101.

At step 404b, the target cell 103 may send SIB1 comprising nonServingCellMII to the UE 101.

At step 405b, the target cell 103 may receive the MII message from the UE 101.

FIG. 4C depicts a message flow diagram of an exemplary method for signalling MII between a system 104 for signalling MII and the UE 101, in accordance with some embodiments of the present disclosure.

At step 401c, the source cell 102 of the system 104 is configured to receive from the UE 101 the MII message that includes at least one of: a subcarrier spacing information, carrier frequency, frequency band indicator, CFR of one or more non-serving cells providing an MBS. Further, CFR may be represented as CFR bandwidth in terms of number of physical resource blocks or as CFR location and bandwidth.

At step 402c, the source cell 102 of the system 104 may be configured to send RRCReestablishment. The RRCReestablishment may be sent in the event of radio link failure. The source cell 102 may receive the MII message during a time period preceding transmission of RRCReestablishment. For example, if the UE 101 initiated transmission of an MBSInterestIndication message during the last one second preceding transmission of RRCReestablishment message by the source cell 102, then upon subsequent connection of the UE 101 with the target cell 102, the UE 101 may send the MII message to the target cell 103 in response to receiving SIB1 comprising nonServingCellMII from the target cell 103.

At step 403c, the target cell 103 may connect with the UE 101 based on the UE 101 receiving RRCReestablishment.

At step 404c, the target cell 103 may send SIB1 comprising nonServingCellMII to the UE 101.

At step 405c, the target cell 103 may receive the MII message from the UE 101.

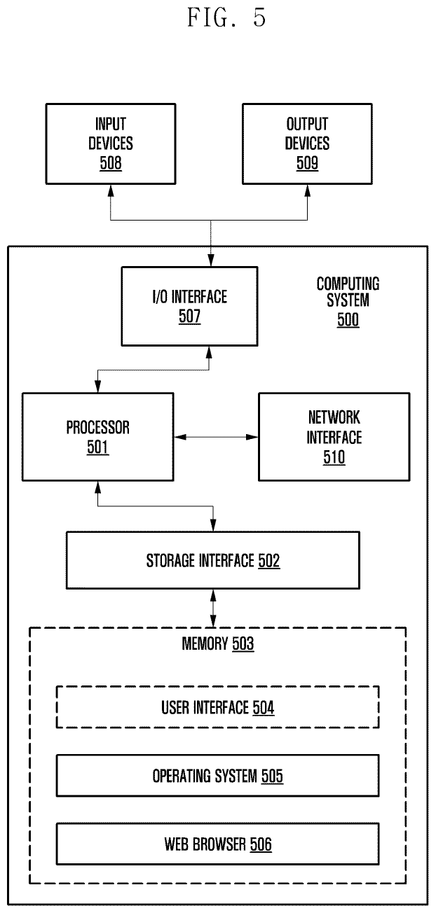

FIG. 5 illustrates a block diagram of an exemplary computer system 400 for implementing embodiments consistent with the present disclosure. The computer system may be, without limitation to, the UE 101, the source cell 102 or the target cell 103. The computer system 600 may include a central processing unit (“CPU” or “processor”) 501. The processor 501 may include at least one data processor for executing processes. The processor 501 may include specialized processing units such as, integrated system (bus) controllers, memory management control units, floating point units, graphics processing units, digital signal processing units, etc.

The processor 501 may be disposed in communication with one or more input/output (I/O) devices 508 and 509 via I/O interface 507. The I/O interface 507 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 507, the computer system 600 may communicate with one or more I/O devices 508 and 509. For example, the input devices 508 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 509 may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

In some embodiments, the processor 501 may be disposed in communication with external elements such as external computer systems, servers, network elements. The network interface 510 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc.

In some embodiments, the processor 501 may be disposed in communication with a memory 503 (e.g., RAM, ROM, etc.) via a storage interface 502. The storage interface 502 may connect to memory 503 including, without limitation, memory drives, removable disc drives, etc., employing connection protocols such as, serial advanced technology attachment (SATA), integrated drive electronics (IDE), IEEE-1394, universal serial bus (USB), fibre channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 503 may store a collection of program or database components, including, without limitation, user interface 504, an operating system 505, a web browser 506 etc. In some embodiments, computer system 600 may store user/application data, such as, the data, variables, records, etc., as described in this disclosure. Such databases may be implemented as fault-tolerant, relational, scalable, secure databases such as Oracle® or Sybase®.

The operating system 505 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™ /7/8, 10 etc.), APPLE® IOS™ GOOGLE® ANDROID™, BLACKBERRY® OS, or the like.

In some embodiments, the computer system 400 may implement the web browser 506 stored program components. The web browser 506 may be a hypertext viewing application, such as MICROSOFT® INTERNET EXPLORER®, GOOGLE™ CHROME™ MOZILLA® FIREFOX®, APPLE® SAFARI®, etc. Secure web browsing may be provided using secure hypertext transport Protocol (HTTPS), secure sockets layer (SSL), transport layer security (TLS), etc. Web browsers 506 may utilize facilities such as AJAX, DHTML, ADOBE® FLASH®, JAVASCRIPT®, JAVA®, application programming interfaces (APIs), etc. In some embodiments, the computer system 600 may implement a mail server stored program component. The mail server may be an Internet mail server such as Microsoft Exchange, or the like. The mail server may utilize facilities such as active server pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as internet message access protocol (IMAP), messaging application programming interface (MAPI), MICROSOFT® exchange, post office protocol (POP), simple mail transfer protocol (SMTP), or the like. In some embodiments, the computer system 600 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium,” where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media may include all computer-readable media except for a transitory. The code implementing the described operations may further be implemented in hardware logic (e.g., an integrated circuit chip, programmable gate array (PGA), application specific integrated circuit (ASIC), etc.).

An “article of manufacture” includes non-transitory computer readable medium, and/or hardware logic, in which code may be implemented. A device in which the code implementing the described embodiments of operations is encoded may include a computer readable medium or hardware logic. Of course, those skilled in the art will recognize that many modifications may be made to this configuration without departing from the scope of the disclosure, and that the article of manufacture may include suitable information bearing medium known in the art.

The terms “an embodiment,” “embodiment,” “embodiments,” “the embodiment,” “the embodiments,” “one or more embodiments,” “some embodiments,” and “one embodiment” mean “one or more (but not all) embodiments of the disclosure(s)” unless expressly specified otherwise.

The terms “including,” “comprising,” “having” and variations thereof mean “including but not limited to,” unless expressly specified otherwise.

The enumerated listing of items does not imply that any or all of the items are mutually exclusive, unless expressly specified otherwise.

The terms “a,” “an” and “the” mean “one or more,” unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 3A, 3B and 3C show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) for signalling a multicast broadcast services (MBS) interest indication (MII), the method comprising:
transmitting, to a source cell, an MII message;
receiving, from the source cell, one of a RRC_Reconfiguration or a RRC_Reconfiguration with reconfigurationWithSync, wherein the RRC_Reconfiguration or the RRC_Reconfiguration with reconfigurationWithSync is received during UE mobility;
connecting with a target cell upon receiving one of the RRC_Reconfiguration or the RRC_Reconfiguration with reconfigurationWithSync; and
transmitting, to the target cell, the MII message.

2. The method of claim 1, wherein connecting with the target cell further comprises:
receiving, from the target cell, a system information block (SIB) comprising nonServingCellMII.

3. The method of claim 1, further comprising transmitting the MII message to the source cell during a time period preceding a reception of one of the RRC_Reconfiguration or the RRC_Reconfiguration with reconfigurationWithSync.

4. The method of claim 1, wherein the MII message includes at least one of subcarrier spacing information, a carrier frequency, a frequency band indicator, or a common frequency resource (CFR) of one or more non-serving cells providing an MBS.

5. A user equipment (UE) for signalling a multicast broadcast services (MBS) interest indication (MII), the UE comprising:
a transceiver; and
a processor operably coupled to the transceiver, the processor configured to:
transmit, to a source cell, an MII message,
receive, from the source cell, one of a RRC_Reconfiguration or a RRC_Reconfiguration with reconfigurationWithSync, wherein the RRC_Reconfiguration or the RRC_Reconfiguration with reconfigurationWithSync is received during UE mobility,
connect with a target cell upon receiving one of the RRC_Reconfiguration or the RRC_Reconfiguration with reconfigurationWithSync, and
transmit, to the target cell, the MII message.

6. The UE of claim 5, wherein the processor is further configured to:
receive, from the target cell, a system information block (SIB) comprising nonServingCellMII.

7. The UE of claim 5, wherein the processor is further configured to transmit the MII message to the source cell during a time period preceding a reception of one of the RRC_Reconfiguration or the RRC_Reconfiguration with reconfigurationWithSync.

8. The UE of claim 5, wherein the MII message includes at least one of subcarrier spacing information, a carrier frequency, a frequency band indicator, or a common frequency resource (CFR) of one or more non-serving cells providing an MBS.

9. A system for signalling a multicast broadcast services (MBS) interest indication (MII), the system comprising:
a target cell; and
a source cell configured to:
receive, from a user equipment (UE), an MII message,
transmit, to the UE, one of a RRC_Reconfiguration or a RRC_Reconfiguration with reconfigurationWithSync, wherein the RRC_Reconfiguration or the RRC_Reconfiguration with reconfigurationWithSync is transmitted during UE mobility,
wherein the target cell is configured to:
connect with the UE based on the UE receiving one of the RRC_Reconfiguration or the RRC_Reconfiguration with reconfigurationWithSync, and
receive, from the UE, the MII message.

10. The system of claim 9, wherein the target cell is further configured to:
connect with the UE; and
transmit, to the UE, a system information block (SIB) comprising nonServingCellMII.

11. The system of claim 9, wherein the source cell receives the MII message from the UE during a time period preceding a reception of one of the RRC_Reconfiguration or the RRC_Reconfiguration with reconfigurationWithSync.

12. The system of claim 9, wherein the MII message includes at least one of subcarrier spacing information, a carrier frequency, a frequency band indicator, or a common frequency resource (CFR) of one or more non-serving cells providing an MBS.

13. A method performed by a system comprising a source cell and a target cell for signalling a multicast broadcast services (MBS) interest indication (MII), the method comprising:
receiving, by the source cell from a user equipment (UE), an MII message;
transmitting, by the source cell to the UE, one of a RRC_Reconfiguration or a RRC_Reconfiguration with reconfigurationWithSync, wherein the RRC_Reconfiguration or the RRC_Reconfiguration with reconfigurationWithSync is transmitted during UE mobility;
connecting, by the target cell with the UE, based on the UE receiving one of the RRC_Reconfiguration or the RRC_Reconfiguration with reconfigurationWithSync; and
receiving, by the target cell from the UE, the MII message.

14. The method of claim 13, wherein connecting with the UE by the target cell further comprises:
transmitting, to the UE, a system information block (SIB) comprising nonServingCellMII.

15. The method of claim 13, wherein the source cell receives the MII message from the UE during a time period preceding a reception of one of the RRC_Reconfiguration or the RRC_Reconfiguration with reconfigurationWithSync.

16. The method of claim 13, wherein the MII message includes at least one of subcarrier spacing information, a carrier frequency, a frequency band indicator, or a common frequency resource (CFR) of one or more non-serving cells providing an MBS.
